(19) United States
(12) Patent Application Publication
(10) Pub. No.: US 2024/0321087 A1
(43) Pub. Date: Sep. 26, 2024

(54) SITUATION DETERMINATION DEVICE, SITUATION DETERMINATION METHOD, AND RECORDING MEDIUM

(71) Applicant: NEC Corporation, Minato-ku, Tokyo (JP)

(72) Inventors: Nana JUMONJI, Tokyo (JP); Kaori IWAFUCHI, Tokyo (JP); Yosuke KIMURA, Tokyo (JP); Chisato SUGAWARA, Tokyo (JP); Takakazu ISHII, Tokyo (JP); Hiromichi HIRATA, Tokyo (JP); Daisuke HASHIZUME, Tokyo (JP); Shouhei OHNO, Tokyo (JP)

(73) Assignee: NEC Corporation, Minato-ku, Tokyo (JP)

(21) Appl. No.: 18/572,956

(22) PCT Filed: Jun. 28, 2021
(86) PCT No.: PCT/JP2021/024276

§ 371 Date: Dec. 21, 2023

(51) Int. Cl. G08G 1/01; G01W 1/02; G08B 21/10; G08G 1/048

(52) U.S. Cl. CPC G08G 1/0133; G01W 1/02; G08B 21/10; G08G 1/0112; G08G 1/048

(57) ABSTRACT

In order to determine a disaster situation in an area that vehicles and the like cannot enter, a situation determination device according to the present invention comprises: an area identification means that uses sensor information acquired from a sensor information acquisition device to identify an area from which ground surface changes are to be acquired; a ground surface information acquisition means that acquires ground surface changes in the identified area, which are results of analysis using results of measurement by a ground surface measurement device; and a disaster determination means that determines the occurrence of a disaster in the area using the ground surface changes.

### TECHNICAL FIELD

The present invention relates to determining a situation of a ground surface, and particularly, to determining a situation related to a disaster.

### BACKGROUND ART

The use of images captured by dashboard cameras (dashcams) mounted on vehicles is spreading (for example, see PTL 1). The in-vehicle device described in PTL 1 detects a situation in which a user requests an image, acquires an image corresponding to the situation from another vehicle, and displays the acquired image.

### CITATION LIST

### Patent Literature

PTL 1: JP 2020-123071 A

### SUMMARY OF INVENTION

### Technical Problem

For example, in a case where a disaster such as flooding of a road occurs when a flood has occurred, the road becomes inaccessible in a disaster range. Therefore, a traffic jam often occurs on roads around the disaster range. However, a traffic jam also occurs for the reason other than disasters. That is, an occurrence of a disaster cannot be determined only from the occurrence of the traffic jam. Further, PTL 1 has a problem that it is difficult to determine a disaster because when a traffic jam has occurred, a vehicle cannot go beyond the traffic jam.

An object of the present invention is to solve the aforementioned problem and to provide a situation determination device or the like that determines a disaster situation in an area that a vehicle or the like cannot enter.

### Solution to Problem

A situation determination device according to an aspect of the present invention includes
an area specifying means that specifies an area where a change of ground surface is to be acquired using sensor information acquired from a sensor information acquisition device,
a ground surface information acquisition means that acquires the change of ground surface, which is a result of analysis using a measurement result acquired by a ground surface measurement device, in the specified area, and
a disaster determination means that determines an occurrence of a disaster in the area using the change of ground surface.

A situation determination system according to an aspect of the present invention includes
the above-described situation determination device,
the sensor information acquisition device that outputs the sensor information to the situation determination device,
the ground surface measurement device that outputs the change of ground surface to the situation determination device, and
a display device that displays a disaster determination result output by the situation determination device.

A situation determination method according to an aspect of the present invention includes
specifying an area where a change of ground surface is to be acquired using sensor information acquired from a sensor information acquisition device,
acquiring the change of ground surface, which is a result of analysis using a measurement result acquired by a ground surface measurement device, in the specified area, and
determining an occurrence of a disaster in the area using the change of ground surface.

A situation determination method according to an aspect of the present invention includes
a situation determination device executing the above-described situation determination method,
the sensor information acquisition device outputting the sensor information to the situation determination device,
the ground surface measurement device outputting the change of ground surface to the situation determination device, and
a display device displaying a disaster determination result output by the situation determination device.

A recording medium according to an aspect of the present invention records a program for causing a computer to execute
specifying an area where a change of ground surface is to be acquired using sensor information acquired from a sensor information acquisition device,
acquiring the change of ground surface, which is a result of analyzing a measurement result acquired by a ground surface measurement device, in the specified area, and
determining an occurrence of a disaster in the area using the change of ground surface.

### Advantageous Effects of Invention

According to the present invention, it is possible to determine a disaster situation in an area that a vehicle or the like cannot enter.

### BRIEF DESCRIPTION OF DRAWINGS

FIG. 1 is a block diagram illustrating an example of a configuration of a situation determination system 80 according to a first example embodiment.

FIG. 2 is a conceptual diagram illustrating an example of a configuration of the situation determination system 80 according to the first example embodiment.

FIG. 3 is a diagram for explaining an example of a determination made by a disaster determination unit or the like.

FIG. 4 is a flowchart illustrating an example of an operation of a situation determination device according to the first example embodiment.

FIG. 5 is a block diagram illustrating an example of a hardware configuration of the situation determination device.

FIG. 6 is a block diagram illustrating an example of a configuration of a situation determination device according to a second example embodiment.

FIG. 7 is a block diagram illustrating an example of a configuration of a situation determination system according to a third example embodiment.

### EXAMPLE EMBODIMENT

Next, example embodiments of the present invention will be described with reference to the drawings. The drawings are for describing the example embodiments of the present invention. However, the example embodiments of the present invention are not limited to the description of the drawings. In addition, similar components in the drawings are denoted by the same reference signs, and repeated description thereof may be omitted. In addition, in the drawings used in the following description, configurations of portions not related to the solution to the problem of the present invention may not be illustrated.

### Terms

The “sensor information acquisition device” is a device including a predetermined sensor to acquire sensor information related to a structure (e.g., a road, a bridge, a slope frame, an embankment, a pier, a revetment, or a runway) and their surroundings. The sensor information will be described later. The sensor information acquisition device may be a moving device (e.g., a dashcam) that is mounted on or towed by a moving object (e.g., a four-wheeled vehicle, a two-wheeled vehicle, a drone, or a person), or may be a fixed device (e.g., a fixed camera). In each example embodiment, an area where “a change of ground surface”, which will be described later, is acquired is specified using the sensor information acquired from the sensor information acquisition device.

The “sensor information” is information (e.g., an image, a velocity, or an acceleration) acquired using a predetermined sensor (e.g., a camera, a speedometer, or an accelerometer) in order to determine a situation of a structure and a situation around the structure. For example, the sensor information is an image captured by or an acceleration measured by a dashcam mounted on a vehicle traveling on a structure such as a road or a bridge. The sensor information may include a plurality of pieces of information (e.g., an image and an acceleration, or a plurality of images such as moving images). Further, the sensor information may include information (an acquisition time, an acquisition position, an acquisition condition, or the like) related to the acquisition of the sensor information. Furthermore, the sensor information may include information related to a moving object (e.g., a vehicle) on which the sensor information acquisition device is mounted. For example, the sensor information may include operation information (e.g., operation information such as an accelerator pedal, a brake pedal, a shift lever, a steering wheel, a wiper, a blinker, and opening and closing of a door of a vehicle) of the moving object.

A specific example of correspondence between the sensor information acquisition device, the sensor, and the sensor information will be described. In a case where the sensor information acquisition device is a dashcam, the sensor is a camera. In a case where the sensor is a camera, the sensor information is an image. In a case where the sensor information acquisition device is a dashcam, the dashcam may include an accelerometer, in addition to a camera, as a sensor. In a case where the sensor is an acceleration, the sensor information is an acceleration. In the following description, a dashcam and an image are used as examples of the sensor information acquisition device and the sensor information. In addition, a vehicle is used as an example of the moving object.

The “synthetic aperture radar (hereinafter referred to as “SAR”)” is a radar that transmits and receives radio waves while a flying object is moving, and obtains an image equivalent to that in the case of an antenna having a large aperture. The resolution in radar observation is improved as the size of the antenna is increased. However, an antenna that can be mounted on an artificial satellite or the like has a limited size. Therefore, the SAR transmits and receives radio waves while flying, using an antenna having an aperture of which an actual length is small (that is, artificially “synthesizes” the “aperture”), thereby improving the resolution in the traveling direction (that is, forming a virtually large antenna). The flying object may be any device as long as it is a device equipped with an SAR. For example, the flying object is an artificial satellite, an aircraft, or an unmanned aerial vehicle.

The SAR outputs an image (hereinafter, referred to as an “SAR image”) as a measurement result. In each example embodiment, a “change of ground surface” is analyzed using SAR images. For example, in each example embodiment, a change in height of ground surface can be analyzed as a change of ground surface using a comparison between two SAR images. Alternatively, the SAR can analyze a change in intensity of ground surface as a change of ground surface. The SAR may use any method as a method for analyzing a change in height and a change in intensity. For example, the SAR may use techniques such as change extraction, time-series interference analysis, and coherent change extraction. Alternatively, the SAR may analyze a change of ground surface by executing machine learning in which past SAR images or the like are applied to a predetermined model, and applying SAR images to an analysis model generated as a result of executing the machine learning. The analysis of the change of ground surface is not limited to the analysis of the change in height of ground surface and the analysis of the change in intensity of ground surface, and may also include another type of analysis (e.g., analysis on a factor of a change of ground surface or analysis on a magnitude of a risk based on a change of ground surface, or the like). However, in each example embodiment, the device used for measuring a change of ground surface is not limited to SAR. Examples of the device for measuring a change of ground surface include an optical sensor mounted on any of an artificial satellite, an aircraft, and an unmanned aerial vehicle, and a laser measuring instrument. In each example embodiment, a change of ground surface may be analyzed using measurement results of devices or systems that measure the ground surface as described above. In the following description, these devices or systems that measure the ground surface will be collectively referred to as a “ground surface measurement device”.

However, the ground surface measurement device may perform analysis using the measurement result and output a “change of ground surface” that is a result of the analysis. That is, the ground surface measurement device may output a measurement result or may output a change of ground surface as an analysis result. In the following description, in order to avoid complication of description, the foregoing cases will be collectively described as a case in which the ground surface measurement device (e.g., the SAR) outputs a “measurement result (e.g., an SAR image)”, unless they need to be particularly distinguished from each other. In the following description, an SAR and an SAR image are used as examples of the ground surface measurement device and the measurement result.

The SAR includes a device capable of acquiring a measurement result using a plurality of frequencies (multispectrum). By using the measurement result using the multispectrum, a type of the ground surface can be analyzed. Therefore, in each example embodiment, a type of the ground surface may be determined by analyzing a measurement result of such a device. The type of the ground surface is determined according to frequencies to be used. For example, the type of the ground surface includes at least one of a water surface, mud, dry soil, grassland, forest, farmland, and snow cover.

The ground surface measurement device such as the SAR can measure an area that a vehicle cannot enter. However, for example, the accuracy of the analysis result (change of ground surface) using the measurement result acquired by the SAR is about several meters. On the other hand, for example, the width of the road may be about several meters. Therefore, as a determination of a disaster situation, it is desirable to make a determination with accuracy higher than that of the analysis using the measurement result of the ground surface measurement device such as the SAR. A determination using sensor information acquired from the dashcam can be achieved with higher accuracy (e.g., about several centimeters to several tens of centimeters). However, the sensor information acquisition device mounted on the vehicle or the like may not be able to acquire information on an area that the vehicle cannot enter. Therefore, in each example embodiment of the present invention, as will be described below, an occurrence of a disaster in an area that a vehicle cannot enter is determined using sensor information acquired from the sensor information acquisition device and a change of ground surface that is an analysis result using a measurement result of the ground surface measurement device.

### First Example Embodiment

A first example embodiment of the present invention will be described with reference to the drawings.

### [Description of Configuration]

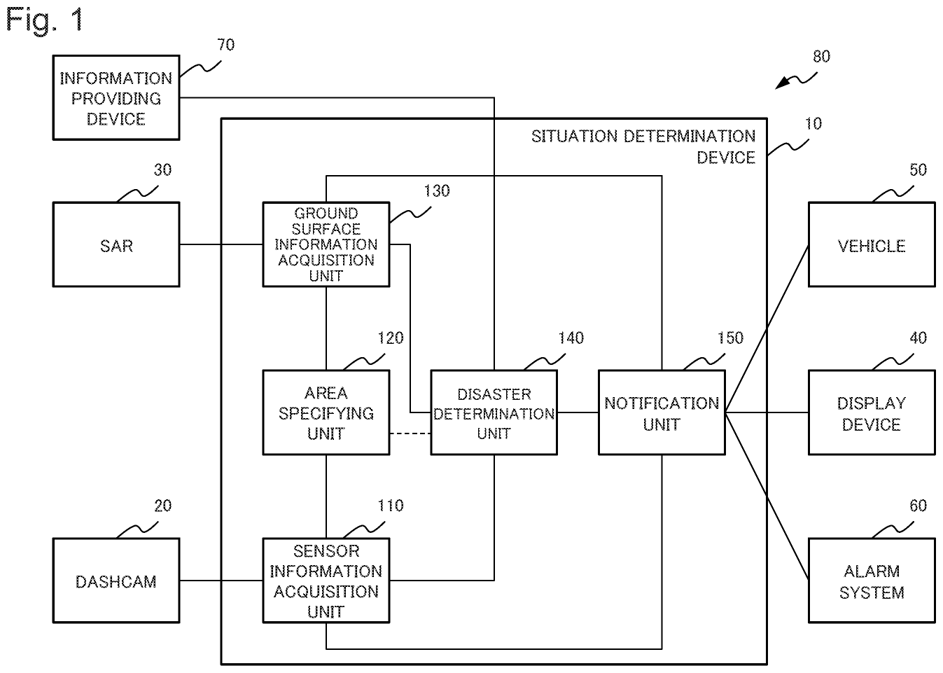

FIG. 1 is a block diagram illustrating an example of a configuration of a situation determination system 80 according to the first example embodiment. The situation determination system 80 includes a situation determination device 10, a dashcam 20, a synthetic aperture radar (SAR) 30, and a display device 40. The situation determination system 80 may further include at least one of a vehicle 50, an alarm system 60, and an information providing device 70. The devices included in the situation determination system 80 are connected to each other via a predetermined communication path (e.g., the Internet). The devices may be directly connected to each other, or may be indirectly connected to each other via a communication device that is not illustrated or the like. The number of components by each component type in FIG. 1 is an example, and is not limited to the number illustrated in FIG. 1. For example, the situation determination system 80 may include a plurality of dashcams 20.

The dashcam 20 outputs sensor information to the situation determination device 10. For example, the dashcam 20 is mounted on the vehicle 50 to acquire sensor information. However, the means for moving the dashcam 20 is not limited to the vehicle 50. For example, the dashcam 20 may be mounted on a moving object (e.g., a drone) other than the vehicle 50. Alternatively, a person or the like may carry the dashcam 20. Alternatively, the dashcam 20 may be a non-moving device such as a fixed camera. The situation determination system 80 is not limited to one dashcam 20, and may include a plurality of dashcams 20. In this case, at least some of the means for moving the dashcams 20 may be different. For example, a dashcam 20 mounted on the vehicle 50 and a dashcam 20 fixed at a predetermined position may be included in the situation determination system 80.

The SAR 30 outputs a measurement result (SAR image) or a change of ground surface to the situation determination device 10. For example, the SAR 30 outputs SAR images as measurement results to the situation determination device 10. In this case, the situation determination device 10 may analyze a “change of ground surface” using the SAR images acquired from SAR 30. When the situation determination device 10 acquires SAR images, the situation determination device 10 may request the SAR 30 for a range (imaging range) of an SAR image to be transmitted. In this case, the SAR 30 may output the acquired SAR images in the imaging range to the situation determination device 10. Alternatively, the SAR 30 may output, to the situation determination device 10, a “change of ground surface” that is a result of analyzing the SAR images. In this case, the situation determination device 10 may request the SAR 30 for a range (analysis range) of a change of ground surface to be transmitted. Then, the SAR 30 may output a change of ground surface in the acquired analysis range. The SAR 30 may output measurement results using a multispectrum.

The display device 40 displays information related to a disaster output by the situation determination device 10. The display device 40 may be any device as long as it is capable of displaying information regarding a disaster. For example, the display device 40 may be a display included in a disaster support system of a local government. In addition, the installation position of the display device 40 may be any installable place, and may be included in any device. For example, the display device 40 may be included in the situation determination device 10. Alternatively, the display device 40 may be a device including the situation determination device 10. Alternatively, the display device 40 may be included in another component (e.g., the dashcam 20 or the alarm system 60) illustrated in FIG. 1, or may be included in a device (e.g., a car navigation device) that is not illustrated mounted on the vehicle 50.

The vehicle 50 travels with the dashcam 20 mounted thereon. The situation determination system 80 may include a plurality of vehicles 50 equipped with dashcams 20. Further, the situation determination system 80 may include a vehicle 50 on which no dashcam 20 is mounted. The vehicle 50 may acquire information related to a disaster from the situation determination device 10. In this case, the vehicle 50 may display the acquired information related to the disaster with respect to a driver of vehicle 50 or the like. For example, in a case where the vehicle 50 is equipped with a dashcam 20, the vehicle 50 may display the acquired information related to the disaster on the dashcam 20. Alternatively, in a case where the vehicle 50 is equipped with a car navigation device, the vehicle 50 may display the acquired information related to the disaster on the car navigation device.

The alarm system 60 acquires information related to a disaster from the situation determination device 10, and outputs a predetermined alarm according to the acquired information related to the disaster. For example, the alarm system 60 may issue an alarm to an area where a disaster has occurred and an area in the vicinity of the area where the disaster has occurred. Alternatively, the alarm system 60 may output an alarm to a terminal device carried by the driver of the vehicle 50.

The information providing device 70 provides information requested by the situation determination device 10. The information providing device 70 is a device that provides information used by the situation determination device 10 to determine a situation. A user or the like of the situation determination device 10 may determine the information providing device 70 according to a disaster determined by the situation determination device 10. For example, the information providing device 70 may be a device of a weather information provider that provides information regarding weather to the situation determination device 10. Alternatively, the information providing device 70 may be a device of a map information provider that provides map information to the situation determination device 10.

The situation determination device 10 specifies an area where a change of ground surface is to be acquired, using sensor information acquired from the dashcam 20. Then, the situation determination device 10 acquires SAR images in the specified area from the SAR 30, and analyzes a change of ground surface using the acquired SAR images. Alternatively, the situation determination device 10 acquires, from the SAR 30, a change of ground surface that is a result of analyzing the SAR images acquired by the SAR 30. That is, although the subject of the analysis is different, in either case, the situation determination device 10 acquires the change of ground surface, which is a result of the analysis using the SAR images acquired by the SAR 30 in the specified area. Then, the situation determination device 10 determines whether a disaster has occurred in the specified area using the acquired change of ground surface. When it is determined that a disaster has occurred, the situation determination device 10 outputs information related to the disaster.

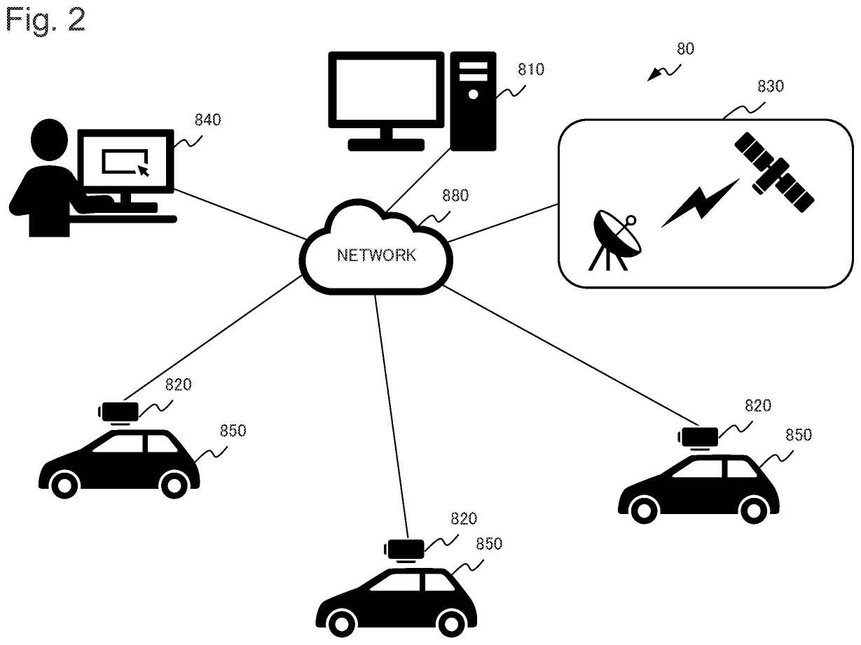

FIG. 2 is a conceptual diagram illustrating an example of a configuration of the situation determination system 80 according to the first example embodiment. The situation determination system 80 in FIG. 2 includes a computer 810 as an example of the situation determination device 10, a dashcam 820 as an example of the dashcam 20, and an SAR system 830 including an artificial satellite and a ground station as an example of the SAR 30. Further, the situation determination system 80 in FIG. 2 includes a terminal device 840 as an example of the display device 40. Further, the situation determination system 80 in FIG. 2 includes a vehicle 850 as an example of the vehicle 50. Further, the situation determination system 80 in FIG. 2 includes a network 880 as a communication path for connecting devices and systems to each other. The network 880 is a communication path that connects devices and systems to each other. The network 880 is not particularly limited as long as it is capable of connecting devices and systems to each other. For example, the network 880 may be the Internet, a public telephone line, or a combination thereof.

The number of components by each component type included in FIG. 2 is an example. For example, the situation determination system 80 may include one, two, or four or more dashcams 820. Alternatively, at least some of the dashcams 820 may not be mounted on the vehicle 850. For example, the situation determination system 80 may not include a vehicle 850. In FIG. 2, the dashcam 820 is shown outside the vehicle 850 for easy understanding. However, the dashcam 820 may be mounted inside the vehicle 850.

The vehicle 850 travels on a road or the like with the dashcam 820 mounted thereon. The dashcam 820 is mounted on the vehicle 850, and acquires sensor information (e.g., an image or an acceleration) related to a road or the like on which the vehicle 850 travels. Then, the dashcam 820 outputs the sensor information to the computer 810. The SAR system 830 outputs an SAR image acquired using an artificial satellite to the computer 810.

Using the sensor information acquired from the dashcam 820, the computer 810 specifies an area where SAR images are to be acquired from the SAR system 830. Then, the computer 810 acquires SAR images in the specified area from the SAR system 830, and analyzes a change of ground surface using the acquired SAR images. That is, the computer 810 acquires the change of ground surface, which is a result of analysis using the SAR images acquired by the SAR system 830, in the specified area. Then, the computer 810 determines whether a disaster has occurred in the specified area using the change of ground surface. When it is determined that a disaster has occurred, the computer 810 outputs information related to the disaster to the terminal device 840. The terminal device 840 displays the information related to the disaster acquired from the computer 810.

The computer 810, the dashcam 820, the SAR system 830, the terminal device 840, and the vehicle 850 included in the situation determination system 80 are not particularly limited. As the computer 810, the dashcam 820, the SAR system 830, the terminal device 840, and the vehicle 850, generally available products and systems may be used. Therefore, the detailed description thereof will be omitted.

Next, the configuration of the situation determination device 10 will be described with reference to FIG. 1. The situation determination device 10 includes a sensor information acquisition unit 110, an area specifying unit 120, a ground surface information acquisition unit 130, a disaster determination unit 140, and a notification unit 150. Each component may store at least some of information specified by each component, information acquired by each component, and information determined by each component in a storage unit that is not illustrated. In this case, each component may acquire necessary information from the storage unit.

The sensor information acquisition unit 110 acquires sensor information from the dashcam 20. Then, the sensor information acquisition unit 110 outputs the sensor information to the area specifying unit 120. The sensor information acquisition unit 110 may output the sensor information to at least one of the disaster determination unit 140 and the notification unit 150. The sensor information acquisition unit 110 may acquire sensor information from a plurality of dashcams 20.

The sensor information acquisition unit 110 acquires sensor information at any timing. For example, the sensor information acquisition unit 110 may acquire sensor information according to a user's instruction. Alternatively, the sensor information acquisition unit 110 may acquire sensor information at a predetermined cycle or when a predetermined condition is satisfied (for example, at the time of receiving an earthquake occurrence notification or at the time of receiving a storm warning). Alternatively, the sensor information acquisition unit 110 may acquire sensor information according to an instruction from the area specifying unit 120, the disaster determination unit 140, or the notification unit 150.

Furthermore, the sensor information acquisition unit 110 may switch the type of sensor information to be acquired using the acquired sensor information. For example, an image is data having a large data amount. Therefore, in order to reduce the communication load, the sensor information acquisition unit 110 may normally acquire sensor information (e.g., a position and an acceleration) of which a data amount is small. Then, when an abnormality has been detected using the acquired sensor information (for example, when the acceleration has greatly changed), the sensor information acquisition unit 110 may acquire an image as sensor information.

The sensor information of which a data amount is smaller than the image is not limited to the acceleration. Next, another example of sensor information of which a data amount is small will be described. An operation of a wiper in the vehicle 50 changes according to an amount of rainfall. Therefore, the sensor information acquisition unit 110 may acquire a wiper operation state (e.g., stop, intermittent, or continuous) of the vehicle 50 equipped with the dashcam 20 as sensor information, and acquire an image as sensor information when the operation of the wiper is continuous. Alternatively, when a traffic jam occurs, the frequency of brake operation increases. Therefore, the sensor information acquisition unit 110 may acquire a frequency of brake operation of the vehicle 50 equipped with the dashcam 20 as sensor information, and acquire an image as sensor information when the frequency of brake operation increases. The case where the frequency of brake operation is high is, for example, a case where the number of times of brake operation per unit time or per unit distance exceeds a threshold. However, the sensor information of which a data amount is small is not limited to what has been described above.

The area specifying unit 120 specifies an area where a change of ground surface is to be acquired using the sensor information acquired by the sensor information acquisition unit 110. For example, when a disaster (e.g., a flood or a mudslide) occurs, it is difficult for vehicles to pass in a direction in which the disaster occurs, and a traffic jam occurs. Therefore, for example, the area specifying unit 120 determines an occurrence of a traffic jam on a road using sensor information acquired from the dashcam 20 mounted on the vehicle 50. More specifically, for example, the area specifying unit 120 may determine a traffic jam by applying an image acquired as sensor information to predetermined image recognition (recognition using a determination model generated using machine learning, recognition using another method, recognition using a combination thereof, or the like). The area specifying unit 120 may determine a traffic jam by using recognition of a plurality of images corresponding to each of a plurality of imaging states such as a time zone or weather.

Then, when a traffic jam occurs, the area specifying unit 120 may specify an area where a change of ground surface is to be acquired using sensor information. That is, the area specifying unit 120 may specify the area when it is determined that a traffic jam occurs in a structure (e.g., a road) included in the sensor information. For example, when a disaster has occurred, a traffic jam occurs on a road in a direction toward a disaster range. Therefore, when a traffic jam occurs, the area specifying unit 120 specifies a road on which the vehicle 50 is traveling using the position of the vehicle 50 equipped with the dashcam 20. Then, the area specifying unit 120 may specify an area of a predetermined size in a traveling direction of the vehicle 50 on the specified road as an area where a change of ground surface is to be acquired. Alternatively, the area specifying unit 120 may determine a position and direction of a traffic jam using an operation of the vehicle 50 or the like included in an image acquired as sensor information, and specify the region using the determined position and direction of the traffic jam.

Alternatively, a vibration (vertical shaking and horizontal shaking) generated based on an earthquake is different from a vibration generated based on the traveling of the vehicle in a change in vibration direction and a change in amplitude with time from generation to disappearance (i.e., a change in three-dimensional acceleration). Therefore, an occurrence of an earthquake may be detected by using a change in acceleration. Therefore, the area specifying unit 120 may determine an occurrence of an earthquake using a change in acceleration detected by the dashcam 20. Then, when it is determined that an earthquake has occurred, the area specifying unit 120 may specify an area using a position of the dashcam 20. For example, the area specifying unit 120 may specify an area having a predetermined size around the position of the dashcam 20.

The area specifying unit 120 may specify an area using sensor information acquired from a plurality of dashcams 20 rather than one dashcam 20. For example, the area specifying unit 120 acquires sensor information such as an image, a position, and a speed of the vehicle 50 from the plurality of dashcams 20. Then, the area specifying unit 120 may determine a traffic jam by using the acquired plurality of pieces of sensor information, and specify an area using positions at which the sensor information with which the traffic jam is determined is acquired and a distribution of degrees of traffic jam (e.g., an average traveling speed of the vehicle 50) at the positions. Alternatively, the area specifying unit 120 may specify an area using sensor information acquired from dashcams 20 mounted on vehicles 50 on both sides (e.g., lanes opposite to each other with the area being sandwiched therebetween in a traveling direction on a road) of a road-blocked area. The operation in this case will be described later with reference to the drawings.

Alternatively, the area specifying unit 120 may determine an earthquake using a plurality of changes in acceleration acquired by a plurality of dashcams 20. For example, the area specifying unit 120 acquires an acceleration, a position, and a detection time from a dashcam 20 that has first detected the acceleration based on the earthquake. Further, the area specifying unit 120 then acquires accelerations, positions, and detection times from one or more dashcams 20 that have detected the accelerations based on the earthquake. Then, the area specifying unit 120 may estimate an outline including a position of the seismic source and a magnitude (seismic intensity) of the earthquake using the acquired accelerations, positions, and detection times from the plurality of dashcams 20. Then, the area specifying unit 120 may specify an area using the estimated position of the seismic source and the estimated magnitude of the earthquake.

The area specifying unit 120 may specify a plurality of areas rather than one area. Then, the area specifying unit 120 outputs the specified area to the ground surface information acquisition unit 130. Instead of the area specifying unit 120, the disaster determination unit 140 may output the area to the ground surface information acquisition unit 130. In this case, the area specifying unit 120 may output the specified area to the disaster determination unit 140. Then, the disaster determination unit 140 outputs the acquired area to the ground surface information acquisition unit 130. The area specifying unit 120 may specify an area using sensor information acquired in advance by the sensor information acquisition unit 110 and stored in a storage unit that is not illustrated, not limited to sensor information newly acquired by the sensor information acquisition unit 110. For example, the area specifying unit 120 may specify an area using sensor information at a predetermined past time point. Alternatively, the area specifying unit 120 may use sensor information stored in a cloud system configured using cloud computing to which the dashcam 20 is connected.

The ground surface information acquisition unit 130 acquires the change of ground surface, which is a result of analysis using SAR images acquired by the SAR 30 in the area specified by the area specifying unit 120. For example, the ground surface information acquisition unit 130 outputs the area specified by the area specifying unit 120 to the SAR 30, acquires SAR images in the area from the SAR 30, and analyzes a change of ground surface between the acquired SAR images. The ground surface information acquisition unit 130 may acquire SAR images in an area wider than the area specified by the area specifying unit 120, and analyze a change of ground surface using SAR images corresponding to the area specified by the area specifying unit 120 among the acquired SAR images. Alternatively, the ground surface information acquisition unit 130 may acquire a change of ground surface, which is a result of analyzing the SAR images in the area specified by the area specifying unit 120, from the SAR 30. In this case, the ground surface information acquisition unit 130 may omit an operation of analyzing the change of ground surface.

As described above, the ground surface information acquisition unit 130 may analyze a change of ground surface by acquiring SAR images from the SAR 30, or may acquire a change of ground surface from the SAR 30. Therefore, as already described, in the description of the present example embodiment, for convenience of description, it is assumed in summary that the ground surface information acquisition unit 130 acquires the change of ground surface, which is a result of analysis using SAR images acquired by the SAR 30, in the specified area. That is, the acquisition of the change of ground surface by the ground surface information acquisition unit 130 includes a case in which SAR images are acquired and a change of ground surface is analyzed using the acquired SAR images, and a case in which a change of ground surface is acquired. The ground surface information acquisition unit 130 may acquire an observation result using a multispectrum from the SAR 30. In this case, the ground surface information acquisition unit 130 may analyze a type of the ground surface, in addition to the change of ground surface, using the acquired observation result. Then, the ground surface information acquisition unit 130 may output a type of the ground surface in addition to the change of ground surface. Therefore, in the following description, the type of the ground surface is also referred to as a change of ground surface. That is, in the following description, the change of ground surface may include a type of the ground surface. Then, the ground surface information acquisition unit 130 outputs the acquired change of ground surface to the disaster determination unit 140.

The disaster determination unit 140 determines whether a disaster has occurred by using the change of ground surface. However, when the ground surface information acquisition unit 130 acquires SAR images from the SAR 30, the disaster determination unit 140 may analyze a change of ground surface by acquiring the SAR images from the ground surface information acquisition unit 130. However, for convenience of description, in the following description, it is assumed that the disaster determination unit 140 acquires the change of ground surface, including a case in which SAR images are acquired. That is, the determination of the disaster using the change of ground surface by the disaster determination unit 140 includes a case where a change of ground surface is analyzed using the SAR images, and a disaster is determined using the change of ground surface which is a result of the analysis.

The disaster determination unit 140 may acquire an area from the area specifying unit 120 and request the ground surface information acquisition unit 130 to acquire a change of ground surface corresponding to the acquired area. In this case, the ground surface information acquisition unit 130 may operate similarly to the case where the area is acquired from the area specifying unit 120. That is, in this case as well, the ground surface information acquisition unit 130 only needs to acquire a change of ground surface, which is a result of analysis using SAR images acquired by the SAR 30, in the specified area.

The disaster determination unit 140 determines whether a disaster has occurred according to any method. For example, in a case where a flood has occurred, the measured surface (that is, a water surface of the flood) is higher than the ground surface due to flooding. That is, the change of ground surface is an increase in height. Alternatively, in a case where a landslide has occurred, the measured ground surface is lower than the original ground surface as earth and sand flow out. That is, the change of ground surface is a decrease in height. There is a high possibility that a disaster has occurred in an area where the height of the ground surface increases to some extent and an area where the height of the ground surface decreases to some extent as described above, that is, an area where an absolute value of a change of ground surface is large. Therefore, for example, in a case where there is a point where the absolute value of the change of ground surface exceeds a predetermined threshold in the specified area, the disaster determination unit 140 determines that a disaster has occurred. The disaster determination unit 140 may determine a disaster using either a case where the change of ground surface is an increase in height or a case where the change of ground surface is a decrease in height, rather than using both cases. In the following description, for convenience of description, “the absolute value of the change of ground surface exceeds the threshold” may be simply referred to as “the change of ground surface exceeds the threshold”. In a case where the change of ground surface includes a type of the ground surface, the disaster determination unit 140 may use the type of the ground surface in determining a disaster.

Further, the disaster determination unit 140 may use information (e.g., weather information or terrain information) acquired from the information providing device 70 in determining an occurrence of a disaster. For example, the disaster determination unit 140 may use a change that is an increase in height of ground surface, by acquiring a topographical map from the information providing device 70 and assuming a flood in an area in the vicinity of a river on the topographical map. Alternatively, the disaster determination unit 140 may use a change that is a decrease in ground surface, assuming a landslide in an area in the vicinity of a terrain with steps such as a cliff in on the topographical map. In this manner, the disaster determination unit 140 may switch the disaster determination method.

Further, the disaster determination unit 140 may determine a range of a disaster. For example, the disaster determination unit 140 may determine a range in which a change of ground surface exceeds the threshold (or a range including a point exceeding the threshold) as a range in which a disaster has occurred (disaster range). A disaster such as a flood occurs to some extent. Therefore, in a case where the range in which the change of ground surface exceeds the threshold is larger than a predetermined area, the disaster determination unit 140 may determine the range as a range in which a disaster has occurred. In a case where the change of ground surface includes a type of the ground surface, the disaster determination unit 140 may use the type of the ground surface in determining a range of a disaster.

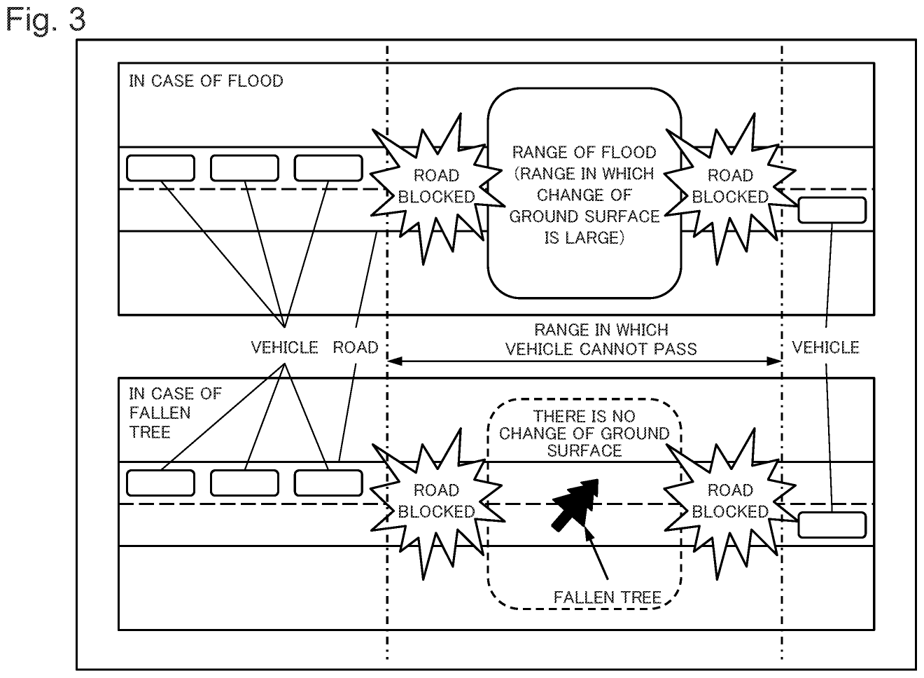

FIG. 3 is a diagram for explaining an example of a determination made by the disaster determination unit 140 or the like. As illustrated in the upper diagram of FIG. 3, when a flood or the like has occurred, a range in which a change of ground surface is large occurs in a range in which a vehicle cannot pass. On the other hand, when a road is blocked due to a fallen tree as illustrated in the lower diagram, no change of ground surface occurs in a range where a vehicle cannot pass. Alternatively, the change of ground surface that has occurred (for example in a portion where the fallen tree is located) is a change that cannot be determined by analysis using a measurement result of the SAR 30. Therefore, the disaster determination unit 140 can determine whether a disaster has occurred by using the change of ground surface. As illustrated in FIG. 3, the disaster determination unit 140 can determine a disaster range by using a change of ground surface.

As illustrated in FIG. 3, the area specifying unit 120 may specify an area using sensor information acquired from dashcams 20 mounted on vehicles 50 on both sides (e.g., roads opposite to each other in a traveling direction) of a road-blocked area. In this case, the area specifying unit 120 may request the sensor information acquisition unit 110 to acquire sensor information from dashcams 20 mounted on vehicles 50 at necessary positions. In FIG. 3, there are two roads connected to the road-blocked area. However, this is an example. In a case where there are three or more roads connected to the road-blocked area, the area specifying unit 120 may acquire sensor information from dashcams 20 mounted on vehicles 50 on the three or more roads. The description returns to the description with reference to FIG. 1.

The disaster determination unit 140 may use sensor information in determining an occurrence of a disaster and a range of a disaster. For example, the disaster determination unit 140 may determine an occurrence of a disaster, a range of a disaster, or the like, using sensor information acquired by dashcams 20 (e.g., the dashcams 20 mounted on the vehicles illustrated in the upper diagram of FIG. 3) around a range in which a change of ground surface is large. Further, the disaster determination unit 140 may request the sensor information acquisition unit 110 to acquire sensor information to be used in determining an occurrence of a disaster. For example, in a case where the sensor information acquisition unit 110 acquires accelerations, the disaster determination unit 140 may request the sensor information acquisition unit 110 to acquire images in a portion around an area having a large change of ground surface among the acquired changes of ground surface, and determine a disaster using the acquired image. In this manner, the sensor information acquisition unit 110 may acquire sensor information according to an instruction from the disaster determination unit 140. Further, the disaster determination unit 140 may use sensor information in determining a disaster range. For example, the disaster determination unit 140 may request the sensor information acquisition unit 110 to acquire sensor information (e.g., images) around an area where a change of ground surface is larger than a predetermined value, and determine a disaster range using the acquired sensor information (e.g., images).

The disaster determination unit 140 may further determine at least one of a type of the disaster and a degree (magnitude) of the disaster by using at least one of the sensor information and the change of ground surface. For example, when a flood has occurred, there is a case where flooding appears in an image acquired by a dashcam 20 around an area that a vehicle cannot pass due to the flood. Alternatively, when a mudslide has occurred, there is a case where some of earth and sand appears in an image acquired by a dashcam 20 around a road that a vehicle cannot pass due to the mudslide. Therefore, the disaster determination unit 140 may determine a type of the disaster using an image including sensor information. Alternatively, there is a case where an earthquake can be determined using an acceleration detected by the dashcam 20. Alternatively, the disaster determination unit 140 can determine a magnitude (seismic intensity) of the earthquake to a certain extent of accuracy from the magnitude of the acceleration based on the earthquake. Therefore, the disaster determination unit 140 may acquire an acceleration from the dashcam 20 as sensor information, and determine an earthquake as a type of the disaster and a magnitude (seismic intensity) of the earthquake as a degree of the disaster using the acquired acceleration. Alternatively, when the image included in the sensor information includes a known structure and a flooding surface of a flood, the disaster determination unit 140 may be able to determine a height of the flooding using the image. Therefore, the disaster determination unit 140 may determine a height of the flooding as a degree of the disaster using the sensor information. In this manner, the disaster determination unit 140 may determine at least one of a type of the disaster and a degree of the disaster using the sensor information.

Alternatively, in the case of flooding, the ground surface remains the same water level over a fairly wide range. On the other hand, in the case of a mudslide, unevenness occurs on the ground surface. In this manner, the distribution of changes of ground surface changes according to a type of the disaster. Therefore, the disaster determination unit 140 may determine a type of the disaster using the distribution of changes of ground surface. In determining a type of the disaster, the disaster determination unit 140 may use information (e.g., topographical information, geological information, or past disaster information) different from the change of ground surface and the sensor information. In a case where the change of ground surface includes a type of the ground surface, the disaster determination unit 140 may use the type of the ground surface in determining at least one of a type of the disaster and a degree of the disaster.

Any type of the disaster may be determined by the disaster determination unit 140. For example, the user of the situation determination device 10 may determine the type of the disaster using information available to the disaster determination unit 140. The type of the disaster is, for example, an earth and sand disaster (slope collapse, mountain collapse, landslide, debris flow, landslip, or the like), a flood damage (flood, river overflow, inundation, storm surge, tsunami, or the like), an earthquake, or an eruption. However, the disaster determination unit 140 may determine not only a natural disaster such as an earth and sand disaster, a flood damage, an earthquake, or an eruption, but also a human disaster such as a fire, a traffic accident, or an explosive terrorism. Then, the disaster determination unit 140 outputs information related to the disaster (information including at least one of an occurrence of a disaster, a range of the disaster, a type of the disaster, and a degree of the disaster) to the notification unit 150 as a determination result.

The notification unit 150 outputs the determination result of the disaster determination unit 140 to a predetermined notification destination. For example, when the disaster determination unit 140 determines an occurrence of a disaster, the notification unit 150 notifies the predetermined notification destination of information related to the disaster determined by the disaster determination unit 140 (information including at least one of whether a disaster has occurred, a range of the disaster, a type of the disaster, and a degree of the disaster). For example, when the disaster determination unit 140 determines an occurrence of a disaster, the notification unit 150 outputs information related to the disaster to at least one of the display device 40, the vehicle 50, and the alarm system 60. The notification unit 150 may select a notification destination. For example, the notification unit 150 may acquire positions of vehicles 50 equipped with dashcams 20 using sensor information, and output information related to the disaster to a vehicle 50 within the disaster range and a vehicle 50 within a predetermined range from the disaster range. Further, the notification unit 150 may determine a position and a traveling direction of the vehicle 50 using sensor information, and output information related to the disaster to a vehicle 50 heading toward the disaster range. In this case, the device to which the notification is to be sent may be any device as long as it is mounted on the vehicle 50. For example, the notification unit 150 may output information related to the disaster to a car navigation device mounted on the vehicle 50.

Alternatively, the notification unit 150 may output at least one of related sensor information and a change of ground surface in addition to the information related to the disaster. For example, the notification unit 150 may output an image of the vicinity of the disaster range (e.g., an image acquired by a dashcam 20 mounted on a vehicle 50 within a predetermined range from the disaster range) to the alarm system 60. The notification unit 150 may request the sensor information acquisition unit 110 to acquire an image to be used in the notification. For example, in a case where no image is acquired in order to reduce a data amount of sensor information to be acquired by the sensor information acquisition unit 110, the notification unit 150 may request the sensor information acquisition unit 110 to acquire an image to be output. When the acquisition of the image is requested, the notification unit 150 may determine a range in which an image is to be acquired using a change of ground surface analyzed or acquired by the ground surface information acquisition unit 130 in addition to or in place of the disaster range determined by the disaster determination unit 140. For example, in order to prevent an occurrence of a secondary disaster or the like, the notification unit 150 may acquire an image in a range where the ground surface has changed to a certain extent although a disaster has not occurred, and output the acquired image.

### [Description of Operation]

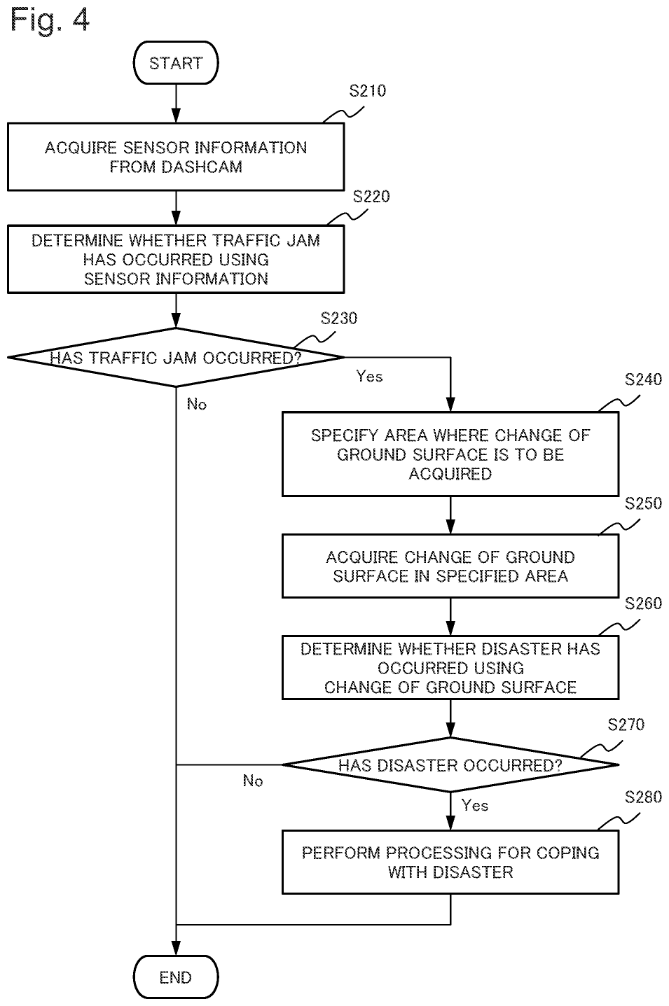

FIG. 4 is a flowchart illustrating an example of an operation of the situation determination device 10 according to the first example embodiment. The sensor information acquisition unit 110 acquires sensor information from a dashcam (step S210). The area specifying unit 120 determines whether a traffic jam has occurred using the sensor information (step S220). When no traffic jam has occurred (“No” in step S230), the situation determination device 10 terminates the operation.

When a traffic jam has occurred (“Yes” in step S230), the area specifying unit 120 specifies an area where a change of ground surface is to be acquired, using the sensor information (step S240). The area specifying unit 120 may not determine whether a traffic jam has occurred. In this case, the situation determination device 10 may omit the operation of steps S220 and S230. The ground surface information acquisition unit 130 acquires, from the SAR 30, a change of ground surface, which is a result of analysis using SAR images acquired by the SAR 30, in the specified area (step S250).

The disaster determination unit 140 determines whether a disaster has occurred using the change of ground surface (step S260). The disaster determination unit 140 may further determine at least one of a range of the disaster, a type of the disaster, and a degree of the disaster. When no disaster has occurred (“No” in step S270), the situation determination device 10 terminates the operation. When a disaster has occurred (“Yes” in step S270), the situation determination device 10 performs predetermined processing for coping with the disaster (step S280). For example, the notification unit 150 notifies a predetermined notification destination (e.g., the display device 40, the vehicle 50, or the alarm system 60) of information related to the disaster (information including at least an occurrence of a disaster, and at least one of a range of the disaster and a type of the disaster). The situation determination device 10 may store the information related to the disaster in a storage unit that is not illustrated, and output the stored information related to the disaster based on a predetermined instruction.

The situation determination device 10 configured as described above according to the first example embodiment can determine a situation of a disaster in an area where a vehicle or the like cannot enter. The reason is as follows.

The situation determination device 10 includes an area specifying unit 120, a ground surface information acquisition unit 130, and a disaster determination unit 140. The area specifying unit 120 specifies an area where a change of ground surface is to be acquired using the sensor information acquired from the sensor information acquisition device (e.g., the dashcam 20). The ground surface information acquisition unit 130 acquires the change of ground surface, which is a result of analysis using a measurement result (e.g., SAR images) acquired by the ground surface measurement device (e.g., the SAR 30), in the specified area. Then, the disaster determination unit 140 determines an occurrence of a disaster in the area using the change of ground surface.

When a flood or the like occurs, the dashcam 20 mounted on the vehicle 50 cannot acquire sensor information in the disaster range. However, when a flood or the like occurs, the ground surface changes (for example, the height of the ground surface rises). The SAR 30 can acquire an SAR image in an area that the vehicle 50 or the like cannot enter. Using the SAR image, a change of ground surface can be analyzed. However, the accuracy of analysis using the measurement result of the SAR 30 or the like may not achieve necessarily required accuracy in specifying a determination area or the like. Therefore, the situation determination device 10 specifies an area where a change of ground surface is to be acquired using sensor information with high measurement accuracy, and determines an occurrence of a disaster using the change of ground surface in the specified area. As a result, the situation determination device 10 can achieve a highly accurate determination as a determination of a disaster situation in the area where the vehicle 50 cannot enter.

Further, the sensor information may include at least one of information related to a moving object (e.g., a vehicle 50 or a drone) equipped with a sensor information acquisition device (e.g., a dashcam 20) and information related to a structure (e.g., a road or a bridge) on which the moving object travels. In this case, the situation determination device 10 can determine a disaster using, for example, the information related to the moving object (for example, the brake of the vehicle 50 is frequently used). Alternatively, the situation determination device 10 can determine a disaster in an area related to a structure (such as a road or a bridge) on which the moving object (such as the vehicle 50) travels.

Further, the structure may be a road, and the moving object may be a vehicle 50 traveling on the road. In this case, the situation determination device 10 can determine a disaster on a road and an area in the vicinity of the road, using sensor information (e.g., an image or an acceleration) acquired by a sensor information acquisition device (e.g., a dashcam 20) mounted on a vehicle 50 traveling on the road.

Further, the sensor information may include at least one of a position and a traveling direction of the moving object (e.g., the vehicle 50) equipped with the sensor information acquisition device (e.g., the dashcam 20). Then, the area specifying unit 120 may specify an area using at least one of the acquired position and traveling direction of the moving object (e.g., the vehicle 50). In this case, the situation determination device 10 can more appropriately specify an area where a disaster is to be determined, using the position and the traveling direction of the moving object.

Further, when it is determined that a traffic jam has occurred using the sensor information, the area specifying unit 120 may specify an area where a change of ground surface is to be acquired. In this case, when a traffic jam has occurred on a road or the like, the situation determination device 10 can determine whether the traffic jam has occurred due to a disaster.

Further, the disaster determination unit 140 may determine an occurrence of a disaster by using sensor information. In this case, the situation determination device 10 can more appropriately determine an occurrence of a disaster.

Further, the disaster determination unit 140 may determine a range of the disaster using at least one of the sensor information and the change of ground surface. In this case, the disaster determination unit 140 can specify a range of the disaster in addition to the occurrence of the disaster. Therefore, the user or the like can appropriate adopt how to cope with the disaster that has occurred.

Further, the disaster determination unit 140 may determine a type of the disaster using at least one of the sensor information and the change of ground surface. Further, the disaster determination unit 140 may determine a degree of the disaster using at least one of the sensor information and the change of ground surface. In this case, the situation determination device 10 can determine a type or a degree of the disaster that has occurred, in addition to the determination of the occurrence of the disaster. Therefore, the user or the like can more appropriately adopt how to cope with the disaster that has occurred.

Further, the disaster determination unit 140 may determine an earthquake as a type of the disaster. In this case, the situation determination device 10 can make a determination corresponding to the earthquake even among disasters.

Further, the disaster determination unit 140 may determine at least one of a magnitude and a seismic source of the earthquake using at least one of the sensor information and the change of ground surface. In this case, the situation determination device 10 can determine the earthquake in a more specific manner.

Further, the situation determination device 10 may include a notification unit 150 that notifies information related to a disaster. When the disaster determination unit 140 determines an occurrence of a disaster, the notification unit 150 may notify information related to the disaster that has occurred. In this case, the situation determination device 10 can notify a predetermined notification destination (e.g., a device used by the user) of information related to the determined disaster. As a result, by providing information related to a disaster or the like to the user or the like, the situation determination device 10 can improve convenience for the user.

Further, the notification unit 150 may select a destination to which the information related to the disaster is to be notified by using the sensor information. In this case, the situation determination device 10 can provide the information related to the disaster to a more appropriate notification destination. As a result, the situation determination device 10 can improve convenience for the user or the like.

Further, the notification unit 150 may notify at least one of the sensor information and the change of ground surface. In this case, the situation determination device 10 can provide more detailed information to the user or the like. As a result, the situation determination device 10 can improve convenience for the user or the like.

The situation determination device 10 may include a sensor information acquisition unit 110 that acquires sensor information. Then, the sensor information acquisition unit 110 may switch the type of sensor information to be acquired using the acquired sensor information. For example, the sensor information acquisition unit 110 may usually acquire sensor information (e.g., an acceleration) of which a data amount is small, and switch the type of sensor information to be acquired to sensor information (e.g., an image) of which a data amount is large when an abnormality is determined using the acquired sensor information. As a result of such an operation, the situation determination device 10 can reduce the sensor information transferring load at a normal time.

Further, the sensor information acquisition unit 110 may acquire sensor information to be used in determining an occurrence of a disaster according to an instruction from the disaster determination unit 140. In this case, the disaster determination unit 140 may determine a disaster using the acquired sensor information. As a result, the situation determination device 10 can more appropriately determine a disaster.

Furthermore, the sensor information acquisition unit 110 may acquire sensor information from a plurality of sensor information acquisition devices (e.g., a plurality of dashcams 20). Then, the area specifying unit 120 may specify an area where a change of ground surface is to be acquired using the sensor information acquired from the plurality of sensor information acquisition devices (e.g., the dashcams 20). In this case, the situation determination device 10 can more appropriately specify an area. As a result, the situation determination device 10 can more appropriately determine a disaster.

The situation determination system 80 includes a situation determination device 10, a sensor information acquisition device (e.g., a dashcam 20), a ground surface measurement device (e.g., a SAR 30), and a display device 40. The situation determination device 10 operates as described above. The sensor information acquisition device (e.g., the dashcam 20) outputs sensor information to the situation determination device 10. The ground surface measurement device (e.g., the SAR 30) outputs a change of ground surface to the situation determination device 10. The display device 40 displays a disaster determination result output by the situation determination device 10. In the situation determination system 80 configured as described above, the situation determination device 10 acquires the change of ground surface from the ground surface measurement device using sensor information acquired from the sensor information acquisition device. Then, the situation determination device 10 outputs a disaster determination result determined using the change of ground surface to the display device 40. Then, the display device 40 displays the disaster determination result. As a result, the situation determination system 80 can determine a situation of a disaster in an area where a vehicle 50 cannot enter and provide a determination result to the user or the like.

### [Hardware Configuration]

Next, a hardware configuration of the situation determination device 10 will be described. Each component of the situation determination device 10 may be configured by a hardware circuit. Alternatively, each component of the situation determination device 10 may be configured using a plurality of devices connected to each other via a network. For example, the situation determination device 10 may be configured using cloud computing. Alternatively, a plurality of components of the situation determination device 10 may be configured by one piece of hardware. Alternatively, the situation determination device 10 may be achieved as a computer device including a central processing unit (CPU), a read only memory (ROM), and a random access memory (RAM). The situation determination device 10 may be achieved as a computer device including a network interface circuit (NIC) in addition to the above-described components.

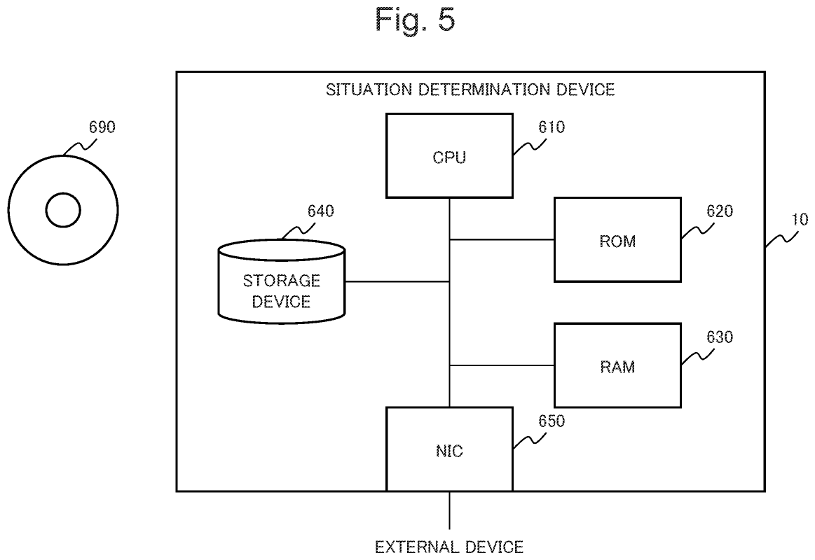

FIG. 5 is a block diagram illustrating an example of a hardware configuration of the situation determination device 10. The situation determination device 10 includes a CPU 610, a ROM 620, a RAM 630, a storage device 640, and an NIC 650, constituting a computer device. The CPU 610 reads a program from the ROM 620 and/or the storage device 640. Then, the CPU 610 controls the RAM 630, the storage device 640, and the NIC 650 based on the read program. Then, the computer including the CPU 610 controls these components to implement the functions of the sensor information acquisition unit 110, the area specifying unit 120, the ground surface information acquisition unit 130, the disaster determination unit 140, and the notification unit 150 illustrated in FIG. 1.

When implementing each function, the CPU 610 may use the RAM 630 or the storage device 640 as a medium for temporarily storing a program and data. Alternatively, the CPU 610 may read a program included in a recording medium 690, which stores the program in a computer readable manner, using a recording medium reading device that is not illustrated. Alternatively, the CPU 610 may receive a program from an external device that is not illustrated via the NIC 650, store the program in the RAM 630 or the storage device 640, and operate based on the stored program.

The ROM 620 stores programs to be executed by the CPU 610 and fixed data. The ROM 620 is, for example, a programmable ROM (P-ROM) or a flash ROM. The RAM 630 temporarily stores programs to be executed by the CPU 610 and data. The RAM 630 is, for example, a dynamic-RAM (D-RAM). The storage device 640 stores data and programs to be stored by the situation determination device 10 for a long period of time. Furthermore, the storage device 640 may operate as a temporary storage device of the CPU 610. The storage device 640 is, for example, a hard disk device, a magneto-optical disk device, a solid state drive (SSD), or a disk array device. The ROM 620 and the storage device 640 are non-transitory recording media. On the other hand, the RAM 630 is a transitory recording medium. The CPU 610 can operate based on a program stored in the ROM 620, the storage device 640, or the RAM 630. That is, the CPU 610 can operate using a non-transitory recording medium or a transitory recording medium.

The NIC 650 relays exchange of data with external devices (the dashcam 20, the SAR 30, the display device 40, and the like) via a network. The NIC 650 is, for example, a local area network (LAN) card. Further, the NIC 650 is not limited to a wired one, and may be a wireless one. The situation determination device 10 configured as described above can obtain effects similar to those of the situation determination device 10 in FIG. 1. This is because the CPU 610 of the situation determination device 10 is capable of implementing functions similar to those of the situation determination device 10 in FIG. 1 based on the program.

### Second Example Embodiment

The situation determination device 10 may use sensor information stored in a device that is not illustrated (e.g., a storage device or a storage system in a predetermined cloud that acquires and stores sensor information from the dashcam 20). Alternatively, the situation determination device 10 may store a disaster determination result in a storage unit that is not illustrated. In these cases, the situation determination device 10 may not include the sensor information acquisition unit 110 and the notification unit 150. Therefore, such a case will be described as a second example embodiment.

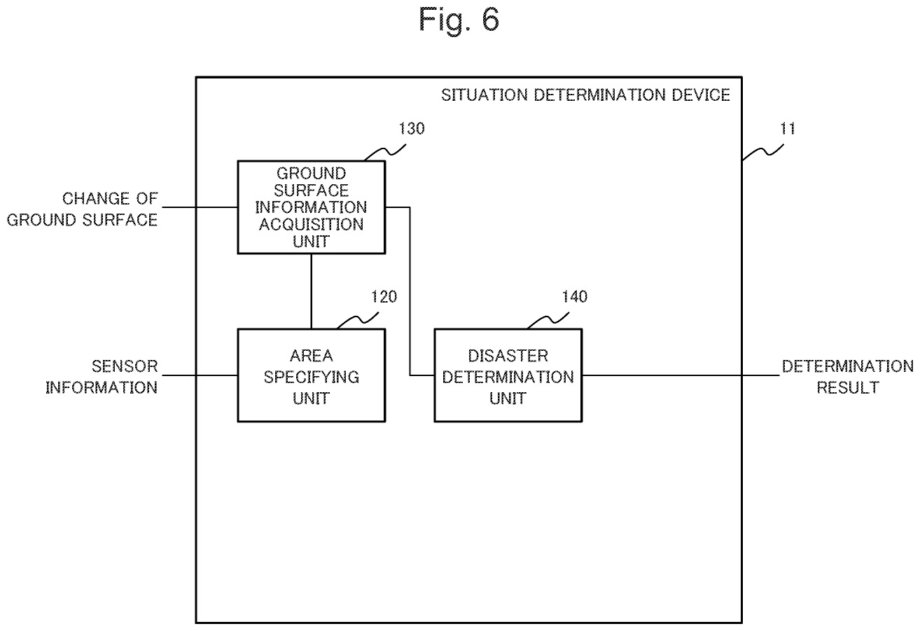

FIG. 6 is a block diagram illustrating an example of a configuration of a situation determination device 11 according to the second example embodiment. The situation determination device 11 includes an area specifying unit 120, a ground surface information acquisition unit 130, and a disaster determination unit 140. The area specifying unit 120 specifies an area where a change of ground surface is to be acquired using the sensor information acquired from the sensor information acquisition device (e.g., the dashcam 20). The ground surface information acquisition unit 130 acquires the change of ground surface, which is a result of analysis using a measurement result (e.g., SAR images) acquired by the ground surface measurement device (e.g., the SAR 30), in the specified area. Then, the disaster determination unit 140 determines an occurrence of a disaster in the area using the change of ground surface. The situation determination device 11 may be configured using the hardware configuration illustrated in FIG. 5. The situation determination device 11 configured as described above can obtain effects similar to those of the situation determination device 10.

### Third Example Embodiment

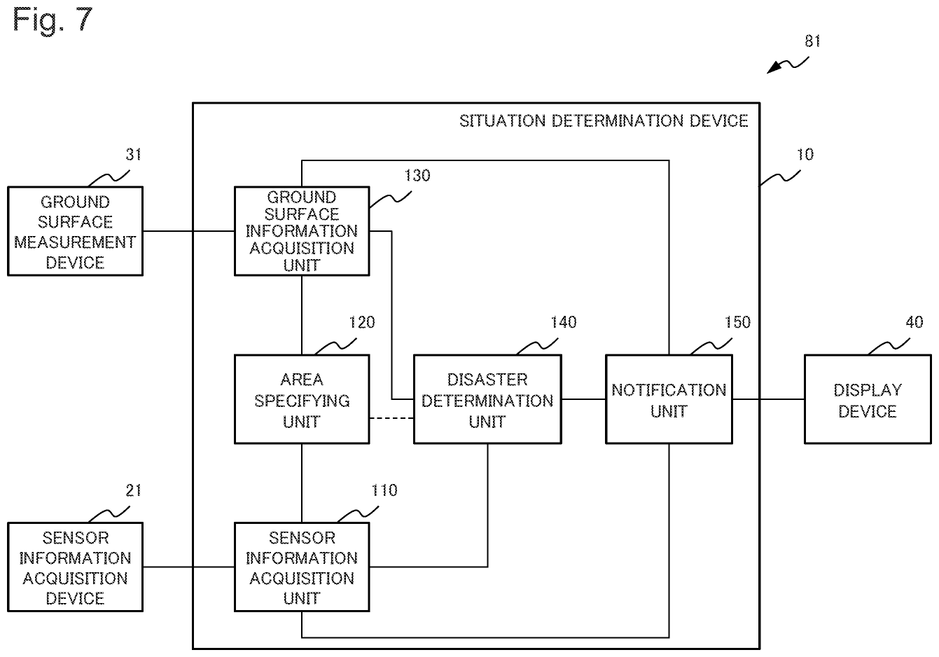

The number of destinations to which the determination result of the situation determination device 10 is output may be one. Furthermore, the situation determination device 10 may not acquire information from the information providing device 70. Therefore, an example of a situation determination system 80 in such a case will be described as a third example embodiment. FIG. 7 is a block diagram illustrating an example of a configuration of a situation determination system 81 according to the third example embodiment. The situation determination system 81 includes a situation determination device 10, a sensor information acquisition device 21, a ground surface measurement device 31, and a display device 40. The situation determination device 10 operates as described above. The sensor information acquisition device 21 (e.g., the dashcam 20) outputs sensor information to the situation determination device 10. The ground surface measurement device 31 (e.g., the SAR 30) outputs a change of ground surface to the situation determination device 10. The display device 40 displays a disaster determination result output by the situation determination device 10. In the situation determination system 80 configured as described above, the situation determination device 10 acquires the change of ground surface from the ground surface measurement device 31 (e.g., the SAR 30) using the sensor information acquired from the sensor information acquisition device 21 (e.g., the dashcam 20). Then, the situation determination device 10 outputs a disaster determination result determined using the change of ground surface to the display device 40. Then, the display device 40 displays the disaster determination result. As a result, the situation determination system 81 configured as described above can obtain effects similar to those of the situation determination system 80.

Some or all of the above-described example embodiments may be described as in the following supplementary notes, but are not limited to the following supplementary notes.

### (Supplementary Note 1)

A situation determination device including:
an area specifying means configured to specify an area where a change of ground surface is to be acquired using sensor information acquired from a sensor information acquisition device;
a ground surface information acquisition means configured to acquire the change of ground surface, which is a result of analysis using a measurement result acquired by a ground surface measurement device, in the specified area; and
a disaster determination means configured to determine an occurrence of a disaster in the area using the change of ground surface.

### (Supplementary Note 2)

The situation determination device according to supplementary note 1, in which
the sensor information includes at least one of information related to a moving object on which the sensor information acquisition device is mounted and information related to a structure on which the moving object travels.

### (Supplementary Note 3)

The situation determination device according to supplementary note 2, in which
the structure is a road, and
the moving object is a vehicle traveling on the road.

### (Supplementary Note 4)

The situation determination device according to supplementary note 2 or 3, in which
the sensor information includes at least one of a position and a traveling direction of the moving object on which the sensor information acquisition device is mounted, and
the area specifying means specifies the area using at least one of the acquired position and traveling direction of the moving object.

### (Supplementary Note 5)

The situation determination device according to any one of supplementary notes 1 to 4, in which
the area specifying means specifies the area when an occurrence of a traffic jam is determined using the sensor information.

### (Supplementary Note 6)

The situation determination device according to any one of supplementary notes 1 to 5, in which
the disaster determination means determines the occurrence of the disaster using the sensor information.

### (Supplementary Note 7)

The situation determination device according to any one of supplementary notes 1 to 6, in which
the disaster determination means determines a range of the disaster using at least one of the sensor information and the change of ground surface.

### (Supplementary Note 8)

The situation determination device according to any one of supplementary notes 1 to 7, in which
the disaster determination means determines a type of the disaster using at least one of the sensor information and the change of ground surface.

### (Supplementary Note 9)

The situation determination device according to any one of supplementary notes 1 to 8, in which
the disaster determination means determines a degree of the disaster using at least one of the sensor information and the change of ground surface.

### (Supplementary Note 10)

The situation determination device according to supplementary note 8, in which
the disaster determination means determines an earthquake as the type of the disaster.

### (Supplementary Note 11)

The situation determination device according to supplementary note 10, in which
the disaster determination means determines at least one of a magnitude and a seismic source of the earthquake using at least one of the sensor information and the change of ground surface.

### (Supplementary Note 12)

The situation determination device according to any one of supplementary notes 1 to 11, in which
the disaster determination means uses a type of the ground surface.

### (Supplementary Note 13)

The situation determination device according to supplementary note 12, in which
the type of the ground surface includes at least one of a water surface, mud, dry soil, grassland, forest, farmland, and snow cover.

### (Supplementary Note 14)

The situation determination device according to any one of supplementary notes 1 to 13, further including:
a notification means configured to notify information related to the disaster, in which
when the disaster determination means determines that the disaster has occurred, the notification means notifies information related to the disaster that has occurred.

### (Supplementary Note 15)

The situation determination device according to supplementary note 14, in which
the notification means selects a destination to which the information related to the disaster is notified using the sensor information.

### (Supplementary Note 16)

The situation determination device according to supplementary note 14 or 15, in which
the notification means notifies at least one of the sensor information and the change of ground surface.

### (Supplementary Note 17)

The situation determination device according to any one of supplementary notes 1 to 16, further including:
a sensor information acquisition means configured to acquire the sensor information, in which
the sensor information acquisition means switches a type of the sensor information to be acquired using the acquired sensor information.

### (Supplementary Note 18)

The situation determination device according to supplementary note 17, in which
the sensor information acquisition means acquires the sensor information to be used in determining the occurrence of the disaster according to an instruction from the disaster determination means, and
the disaster determination means determines an occurrence of a disaster using the acquired sensor information.

### (Supplementary Note 19)

The situation determination device according to supplementary note 17 or 18, in which
the sensor information acquisition means acquires the sensor information from a plurality of sensor information acquisition devices, and
the area specifying means specifies the area where the change of ground surface is to be acquired using the sensor information acquired from the plurality of sensor information acquisition devices.

### (Supplementary Note 20)

A situation determination system including:
the situation determination device according to any one of supplementary notes 1 to 19;
the sensor information acquisition device configured to output the sensor information to the situation determination device;
the ground surface measurement device configured to output the change of ground surface to the situation determination device; and
a display device configured to display a disaster determination result output by the situation determination device.

### (Supplementary Note 21)

A situation determination method including:
specifying an area where a change of ground surface is to be acquired using sensor information acquired from a sensor information acquisition device;
acquiring the change of ground surface, which is a result of analysis using a measurement result acquired by a ground surface measurement device, in the specified area; and
determining an occurrence of a disaster in the area using the change of ground surface.

### (Supplementary Note 22)

A situation determination method including:
a situation determination device executing the situation determination method according to supplementary note 21;
the sensor information acquisition device outputting the sensor information to the situation determination device;
the ground surface measurement device outputting the change of ground surface to the situation determination device; and
a display device displaying a disaster determination result output by the situation determination device.

### (Supplementary Note 23)

A recording medium recording a program for causing a computer to execute:
specifying an area where a change of ground surface is to be acquired using sensor information acquired from a sensor information acquisition device;
acquiring the change of ground surface, which is a result of analysis using a measurement result acquired by a ground surface measurement device, in the specified area; and
determining an occurrence of a disaster in the area using the change of ground surface.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

10 Situation determination device
11 Situation determination device
20 Drive recorder
21 Sensor information acquisition device
30 SAR
31 Ground surface measurement device
40 Display device
50 Vehicle
60 Alarm system
70 Information providing device
80 Situation determination system
110 Sensor information acquisition unit
120 Area specifying unit
130 Ground surface information acquisition unit
140 Disaster determination unit
150 Notification unit
610 CPU
620 ROM
630 RAM
640 Storage device
650 NIC
810 Computer
820 Drive recorder
830 SAR system
840 Terminal device
850 Vehicle
880 Network

What is claimed is:

1. A situation determination device comprising:
a memory; and
at least one processor coupled to the memory,
the processor performing operations, the operations comprising:
specifying an area where a change of ground surface is to be acquired using sensor information acquired from a sensor information acquisition device;
acquiring the change of ground surface, which is a result of analysis using a measurement result acquired by a ground surface measurement device, in the specified area; and
determining an occurrence of a disaster in the area using the change of ground surface.

2. The situation determination device according to claim 1, wherein
the sensor information includes at least one of information related to a moving object on which the sensor information acquisition device is mounted and information related to a structure on which the moving object travels.

3. The situation determination device according to claim 2, wherein
the structure is a road, and
the moving object is a vehicle traveling on the road.

4. The situation determination device according to claim 2, wherein
the sensor information includes at least one of a position and a traveling direction of the moving object on which the sensor information acquisition device is mounted, and
the operations further comprise:
specifying the area using at least one of the acquired position and traveling direction of the moving object.

5. The situation determination device according to claim 1, wherein the operations further comprise:
specifying the area when an occurrence of a traffic jam is determined using the sensor information.

6. The situation determination device according to claim 1, wherein the operations further comprise:
determining the occurrence of the disaster using the sensor information.

7. The situation determination device according to claim 1, wherein the operations further comprise:
determining a range of the disaster using at least one of the sensor information and the change of ground surface.

8. The situation determination device according to claim 1, wherein the operations further comprise:
determining a type of the disaster using at least one of the sensor information and the change of ground surface.

9. The situation determination device according to claim 1, wherein the operations further comprise:
determining a degree of the disaster using at least one of the sensor information and the change of ground surface.

10. The situation determination device according to claim 8, wherein the operations further comprise:
determining an earthquake as the type of the disaster.

11. The situation determination device according to claim 10, wherein the operations further comprise:
determining at least one of a magnitude and a seismic source of the earthquake using at least one of the sensor information and the change of ground surface.

12. The situation determination device according to claim 1 wherein the operations further comprise:
using a type of the ground surface.

13. The situation determination device according to claim 12, wherein
the type of the ground surface includes at least one of a water surface, mud, dry soil, grassland, forest, farmland, and snow cover.

14. The situation determination device according to claim 1, wherein the operations further comprise:
when determining that the disaster has occurred, notifying information related to the disaster that has occurred.

15. The situation determination device according to claim 14, wherein the operations further comprise:
selecting a destination to which the information related to the disaster is notified using the sensor information.

16. The situation determination device according to claim 14, wherein the operations further comprise:
notifying at least one of the sensor information and the change of ground surface.

17. The situation determination device according to claim 1, wherein the operations further comprise:
acquiring the sensor information, and
switching a type of the sensor information to be acquired, using the acquired sensor information.

18. The situation determination device according to claim 17, wherein the operations further comprise:
acquiring the sensor information to be used in determining the occurrence of the disaster according to an instruction, and
determining an occurrence of a disaster using the acquired sensor information.

19-20. (canceled)

21. A situation determination method comprising:
specifying an area where a change of ground surface is to be acquired using sensor information acquired from a sensor information acquisition device;
acquiring the change of ground surface, which is a result of analysis using a measurement result acquired by a ground surface measurement device, in the specified area; and
determining an occurrence of a disaster in the area using the change of ground surface.

22. (canceled)

23. A non-transitory computer-readable recording medium recording a program for causing a computer to execute:
specifying an area where a change of ground surface is to be acquired using sensor information acquired from a sensor information acquisition device;
acquiring the change of ground surface, which is a result of analysis using a measurement result acquired by a ground surface measurement device, in the specified area; and
determining an occurrence of a disaster in the area using the change of ground surface.
